(19) United States
(12) Patent Application Publication
(10) Pub. No.: US 2003/0216060 A1
(43) Pub. Date: Nov. 20, 2003

(54) Sucking disk type USB extension socket

(76) Inventor: Eric Oh-Yang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/147,056

(22) Filed: May 17, 2002

(51) Int. Cl. H01R 13/60

(52) U.S. Cl. 439/42

(57) ABSTRACT

The present invention provides a sucking disk type USB extension socket for plugging with a USB device. The USB extension socket comprises a USB seat and an extension transmission cable. The USB seat has a connection socket therein, which is electrically connected to one end of the extension transmission cable. The other end of the extension transmission cable has a USB connector. At least a sucking disk is disposed on the USB seat. The USB seat can be fixed at any position through the design of the sucking disk type fixing structure thereof. The present invention has the advantages of high space usage and convenient and flexible use.

### FIELD OF THE INVENTION

The present invention relates to a USB extension socket and, more particularly, to a sucking disk type USB extension socket having high space usage to be arbitrarily fixed at an appropriate position.

### BACKGROUND OF THE INVENTION

USB interfaces have been extensively applied to peripheral I/O products. Present common products adopting USB interfaces include mice, PDAs, card readers, MP3 players, digital cameras, and scanners. Except compact ones capable of directly plugging in USB insertion holes at the back of a desktop computer or a notebook computer, most use extension cables for data transmission.

Regardless of portable or fixedly connected peripherals, the insertion of a USB interface is very inconvenient because of the placement way of the host computer. A user must stick his head and hand to the back of the computer for insertion and pulling out a USB interface, resulting in much inconvenience. In order to provide more convenient space of usage for the user, one kind of USB extension socket has been provided to extend USB insertion holes at the back of a computer to the front thereof so as to provide a USB extension socket for insertion of portable USB devices within the range of both hands. The user can thus insert or pull out a USB interface without having to go far. This kind of extension socket usually can only be placed on the desk, and there is no design for fixing. Therefore, the extension socket easily falls off or the USB device plugged into the extension socket easily comes off to break connection due to being impacted by the user by accident when there are many things on the desk, resulting in much inconvenience of the user or even damaging the USB device plugged into the extension socket.

Accordingly, the present invention aims to propose a sucking disk type USB extension socket having fixing function to resolve the problems in the prior art.

### SUMMARY AND OBJECTS OF THE PRESENT INVENTION

The primary object of the present invention is to propose a sucking disk type USB extension socket having high space usage. The USB extension socket can be fixed at any appropriate position according to user's liking to facilitate storage, use, and adherence.

Another object of the present invention is to propose a sucking disk type USB extension socket having the characteristics of practical application and convenience.

Yet another object of the present invention is to propose a sucking disk type USB extension socket so that a portable USB device plugged therein will not come off to break connection or fall off to be damaged through the design of the fixing structure thereof.

To achieve the above objects, the present invention proposes a sucking disk type USB extension socket, which comprises a USB seat and an extension transmission cable. At least a sucking disk is also disposed on the USB seat.

The various objects and advantages of the present invention will be more readily understood from the following detailed description when read in conjunction with the appended drawings, in which:

### BRIEF DESCRIPTION OF DRAWINGS

FIG. 1 is a perspective view of the present invention;

FIG. 2 is a side view of the present invention; and

FIG. 3 shows the use state according to an embodiment of the present invention.

### DETAILED DESCRIPTION OF PREFERRED EMBODIMENT

Because of simple use, fast transmission speed, convenient connection, plug-and-play characteristic, and no additional power source required, USB transmission interfaces are the most widely used connection way in present desktop computers, notebook computers, printers, digital cameras, and other application devices. For compact portable USB devices, in addition to using an extension cable for extending usage space, one kind of extension socket has been proposed to provide more convenient connection. The present invention modifies the drawbacks of the prior art extension socket, and proposes a USB extension socket having high space usage.

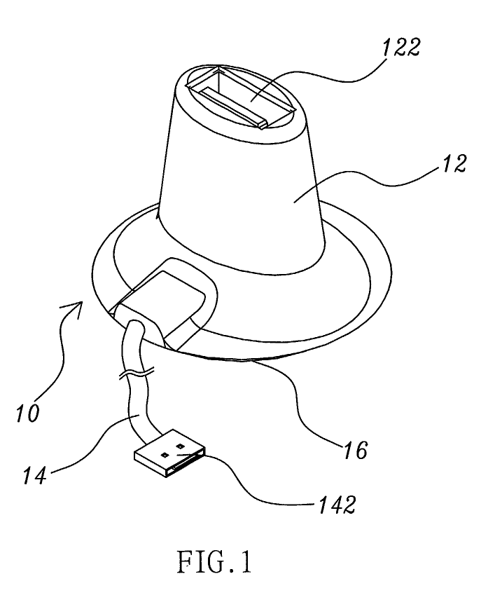

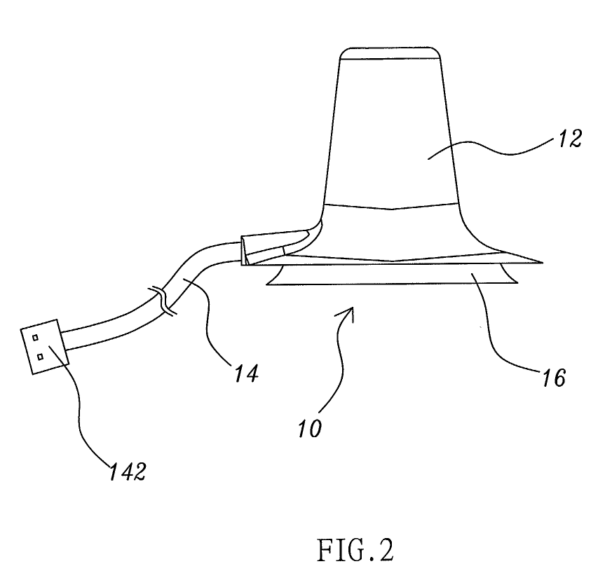

As shown in FIGS. 1 and 2, a sucking disk type USB extension socket 10 comprises a USB seat 12 and an extension transmission cable 14. A connection socket 122 is disposed in the USB seat 12 to provide a receiving space for plugging with a portable USB device, which usually includes USB wireless Ethernet card, a portable (flash) storage, and so on. One end of the extension transmission cable 14 is electrically connected to the connection socket 122 in the USB seat 12. The other end of the extension transmission cable 13 has a USB connector 142 to be plugged into a USB insertion hole at the back of a desktop computer or a notebook computer. A sucking disk 16 is disposed at the bottom of the USB seat 12. The USB extension socket is fixed on the surface of any appropriate position using the sucking disk 16.

In addition that at least a sucking disk is disposed at the bottom of the USB seat 12, a sucking disk can also be directly disposed on the side surface of the USB seat. Or a hook can be installed on the surface of the USB seat so that the USB extension socket can be hooked at a predetermined position to provide more flexible usage for the user.

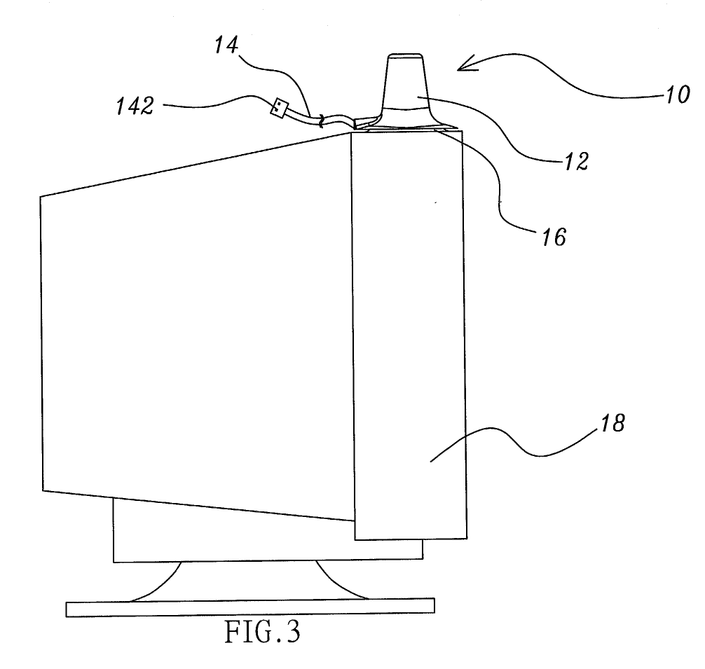

When the USB connector 142 of the above sucking disk type USB extension socket 10 has been plugged on a host computer, the user can directly adhere and fix the sucking disk 16 at the bottom of the USB seat 12 on a computer screen 18 to facilitate plugging of a portable USB device, as shown in FIG. 3. More flexible usage can thus be provided for the user without occupying the tabletop. Besides, the USB extension socket 10 can also be adhered and fixed at any position within the range of the user's hands. Because the USB extension socket 10 is fixed, it will not easily displace or tilt.

Therefore, the sucking disk type USB extension socket of the present invention has the advantage of high space usage and the characteristics of practical application and convenience. Through the design of sucking disk type fixing structure of the present invention, a portable USB device plugged therein will not come off to break connection or fall off to be damaged. Moreover, the USB extension socket can be fixed at any appropriate position according to user's liking to facilitate storage, use, and adherence.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A sucking disk type USB extension socket comprising a USB seat and an extension transmission cable, said USB seat having a connection socket therein for plugging with a USB device, one end of said extension transmission cable being electrically connected to said connection socket in said USB seat, the other end of said extension transmission cable having a USB connector, at least a sucking disk being disposed on said USB seat.

2. The sucking disk type USB extension socket as claimed in claim 1, wherein a hook is further provided on said USB seat.

3. The sucking disk type USB extension socket as claimed in claim 1, wherein said sucking disk is disposed at a bottom or on a side face of said USB seat.
